(19) United States
(12) Patent Application Publication
(10) Pub. No.: US 2004/0111436 A1
(43) Pub. Date: Jun. 10, 2004

(54) Data editing apparatus, data editing method, and data editing program

(75) Inventors: Michio Nagai, Tokyo (JP); Takafumi Onishi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/678,518

(22) Filed: Oct. 2, 2003

(30) Foreign Application Priority Data
Oct. 9, 2002 (JP) 2002-296600

(51) Int. Cl. G06F 17/00

(52) U.S. Cl. 707/104.1

(57) ABSTRACT

According to the present invention, when image data displayed on a monitor is linked with audio data using a digital recorder as a remote controller, an operator is permitted to sequence a plurality of image data to sequentially select the image data. After sound recording is started through the digital recorder, the operator turns on a shutter button of the digital recorder, thus closing an audio file and opening a new audio file. Further, the next image data is displayed. After that, the operator turns on a stop button of the digital recorder to return a screen to an edit screen. Then, all of audio files currently formed are connected to each other in the order of selection, the plurality of mage data are linked as indexes with the connected audio files in the sequence such that each image data is inserted between the audio files, thus forming an audio album.

This application is based upon and claims the benefit of priority from the prior Japanese Patent Application No. 2002-296600 filed on Oct. 9, 2002; the entire contents of which are incorporated herein by reference.

### BACKGROUND OF THE INVENTION

1. Field of the Invention

The present invention relates to a data editing apparatus and method and program whereby image data can be linked with audio data at a desired time position therein with a simple operation.

2. Description Related Art Statement

Related techniques of linking one audio data with one image data to form an audio album include, for example, a technique disclosed in Japanese Unexamined Patent Application Publication No. 2001-69453.

In other words, Japanese Unexamined Patent Application Publication No. 2001-69453 discloses the following technique: When a sound recording button is turned on to record sound through a microphone, audio data of the sound is recorded as an audio file in a memory. After that, a still picture photographing button is operated to take a still picture through an image pickup device and image data of the picture is recorded as an image file in the memory. Subsequently, the audio file, the image file related thereto, and display timing thereof are defined in a still-picture playback timing management file. Upon sound playback, according to the defined display timing, sound playback is performed and the still picture related to the sound is displayed at the timing.

### SUMMARY OF THE INVENTION

A data editing apparatus according to the present invention includes: image selection means for sequencing a plurality of image data to sequentially select the image data; recording means for converting supplied audio signals into audio data of digital signals to record the resultant data; indication means for indicating a playback position in the audio data to be linked with the corresponding image data; and data link means for linking in the sequence each image data selected by the image selection means, with the audio data at the corresponding playback position indicated by the indication means.

The above and other objects, features and advantages of the invention will become more clearly understood from the following description referring to the accompanying drawings.

### BRIEF DESCRIPTION OF THE DRAWINGS

FIG. 1 is an appearance of a data editing system;

FIG. 2 is a block diagram schematically showing the structure of a digital recorder;

FIG. 3 is a block diagram showing data editing functions in a personal computer;

FIG. 4 is a diagram explaining the structure of an audio file;

FIG. 5 is a flowchart showing a data editing routine;

FIG. 6 is a diagram explaining an initial screen of an audio album creation window;

FIG. 7 is a diagram explaining the sequence setting of image data in the audio album creation window;

FIG. 8 is a diagram explaining another state of the sequence setting of image data in the audio album creation window;

FIG. 9 is a diagram explaining further another state of the sequence setting of image data in the audio album creation window;

FIG. 10 is a diagram explaining an album edit window; and

FIG. 11 is a diagram explaining another state of the album edit window.

### DETAILED DESCRIPTION OF THE PREFERRED EMBODIMENTS

An embodiment of the present invention will now be described hereinbelow with reference to the drawings.

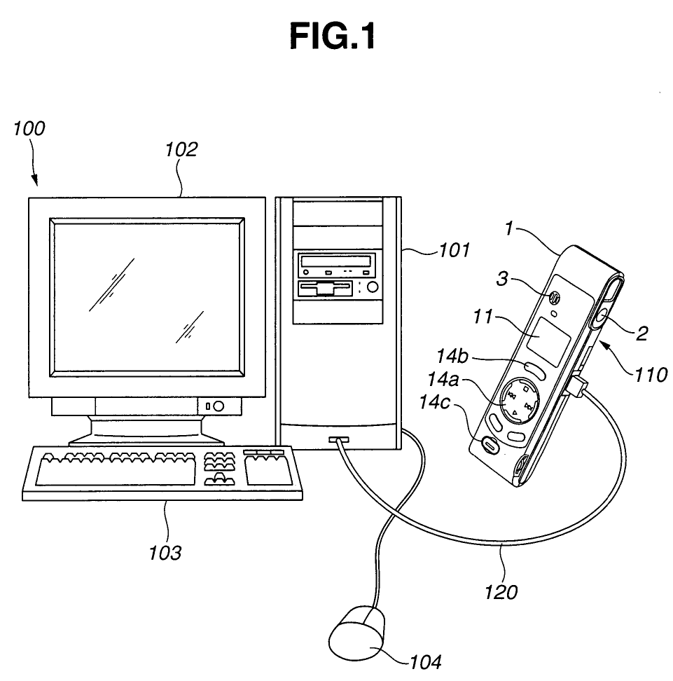

As shown in FIG. 1, according to the present embodiment, a data editing system comprises a personal computer 100 and a digital recorder 110. The personal computer 100 comprises a personal computer body 101, a monitor 102, a keyboard 103, and a mouse 104. The personal computer body 101 is connected to the digital recorder 110 via a suitable data transmission cable 120 such as a USB cable.

The digital recorder 110 has a digital camera function in addition to a normal digital sound recording function. A finder 1 comprising the camera function and a taking lens 2, which is adjacent to the finder 1, are provided on the side surface of the upper portion of the recorder body. A built-in microphone (MIC) 3 for converting sound into electric signals is arranged on the front surface of the upper portion thereof.

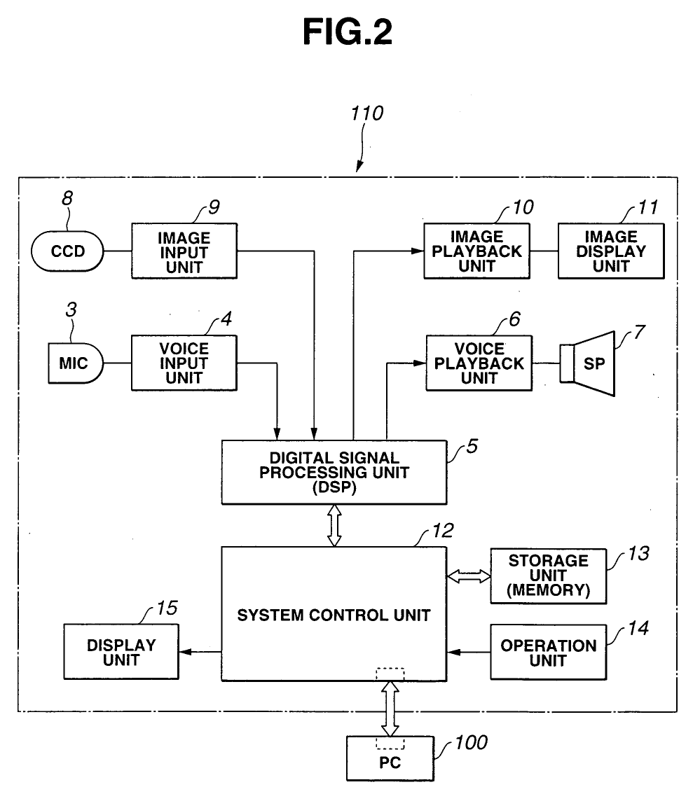

Referring to FIG. 2, an output terminal of the built-in microphone 3 is connected to an input terminal of an audio input unit 4. An output terminal of the audio input unit 4 is connected to an input terminal of a digital signal processing unit (DSP) 5. Further, an output terminal of the digital signal processing unit (DSP) 5 is connected to an input terminal of an audio playback unit 6. An output terminal of the audio playback unit 6 is connected to an input terminal of a speaker (SP) 7, which is arranged on the rear of the recorder body.

Further, an output terminal of an image pickup device (comprising, for example, charge-coupled devices) 8, arranged at an image formation portion of the taking lens 2, for converting a received image into electric signals is connected to an input terminal of an image input unit 9. An output terminal of the image input unit 9 is connected to the input terminal of the digital signal processing unit 5.

The output terminal of the digital signal processing unit 5 is connected to an input terminal of an image playback unit 10. Further, an output terminal of the image playback unit 10 is connected to an input terminal of an image display unit 11, which comprises, for example, a TFT type LCD and is arranged on the front surface of the recorder body. The image display unit 11 displays image data, audio data, or attribute information of image data.

The audio input unit 4 comprises: a microphone amplifier for amplifying an electric signal supplied from the built-in microphone 3; a low-pass filter for cutting an unnecessary frequency band; and an A/D converter for converting a supplied audio signal (analog signal) into a digital signal (each of the respective components being not shown in the diagram). Further, the audio playback unit 6 reproduces audio data and comprises a D/A converter for converting a supplied digital signal into an analog signal, a low-pass filter for cutting an unnecessary frequency band, and a power amplifier for amplifying an audio signal(each of the respective components being not shown in the diagram).

The image input unit 9 converts various pixel signals supplied from the image pickup device 8 into digital signals. The image input unit 9 comprises various circuits for controlling iris, gain, and white balance, and an A/D converter (which are not shown in the diagram). Further, the image playback unit 10 converts supplied digital signals into analog signals and comprises a video control circuit and a D/A converter (both of which are not shown).

The digital signal processing unit (DSP) 5 is controlled by a system control unit 12, which will be described later. Upon sound recording, the digital signal processing unit 5 encodes (compresses) the audio and image digital signals to audio data and image data in the respective predetermined encoding formats every frame. The encoded each data is temporarily stored in a buffer memory (not shown) of the system control unit 12. Upon playback, the digital signal processing unit 5 decodes (decompresses) audio data and image data from the buffer memory every frame.

Further, the digital signal processing unit (DSP) is connected to the system control unit 12 through a bus line. In addition to the digital signal processing unit 5, a storage unit (memory) 13, an operation unit 14, and a display unit 15 are connected to the system control unit 12.

The system control unit 12 comprises a CPU and controls the whole of the present recorder. The storage unit (memory) 13 comprises a nonvolatile semiconductor memory such as a flash memory. Upon sound recording, the storage unit 13 stores audio data and image data, encoded by the digital signal processing unit 5, through the buffer memory (not shown) of the system control unit 12. At this time, the storage unit 13 also stores index information related to audio data and image data. The storage unit 13 has an audio storage area in which audio data is stored and an image storage area in which image data is stored. The audio storage area includes an audio folder to store a plurality of audio data and the image storage area includes an image folder to store a plurality of image data.

Further, the operation unit 14 comprises a set of operation buttons for controlling various functions. Namely, the operation unit 14 includes a sound recording button (REC), a playback button (PLAY), a stop button (STOP), a fast-forward button (FF), a fast-rewind button (REW), a menu button (MENU), a hold button (HOLD), an erasing button (ERASE), and a shutter button.

Specifically, as shown in FIG. 1, the playback button (PLAY), the stop button (STOP), the fast-forward button (FF), and the fast-rewind button (REW) are integrated into a multi-function button 14a arranged on the front surface of the recorder body. A sound recording button (REC) 14b is arranged above the multi-function button 14a. Further, a shutter button 14c is arranged below the multi-function button 14a. The shutter button 14c is a two-position button. When the button is pressed halfway, focusing is achieved due to auto-focusing control. When the button is pressed fully, an image is captured.

The display unit 15 displays an operation mode indicated when a predetermined sequence operation is started by operating any button of the operation unit 14, or displays a situation of the subsequent operation. For example, when the sound recording button (REC) 14b is pressed, the display unit 15 displays a sound recording elapsed time, a recordable remaining time, and a file number. When the menu button (MENU) is pressed, the display unit 15 displays information related to the selection of functions, for example, the sensitivity of the microphone (high/low), a sound recording mode (standard/long), and an alarm (on/off).

Further, when the system control unit 12 has a clock function, the display unit 15 displays the current date and time. In the present embodiment, the image display unit 11 has the above functions of the display unit 15.

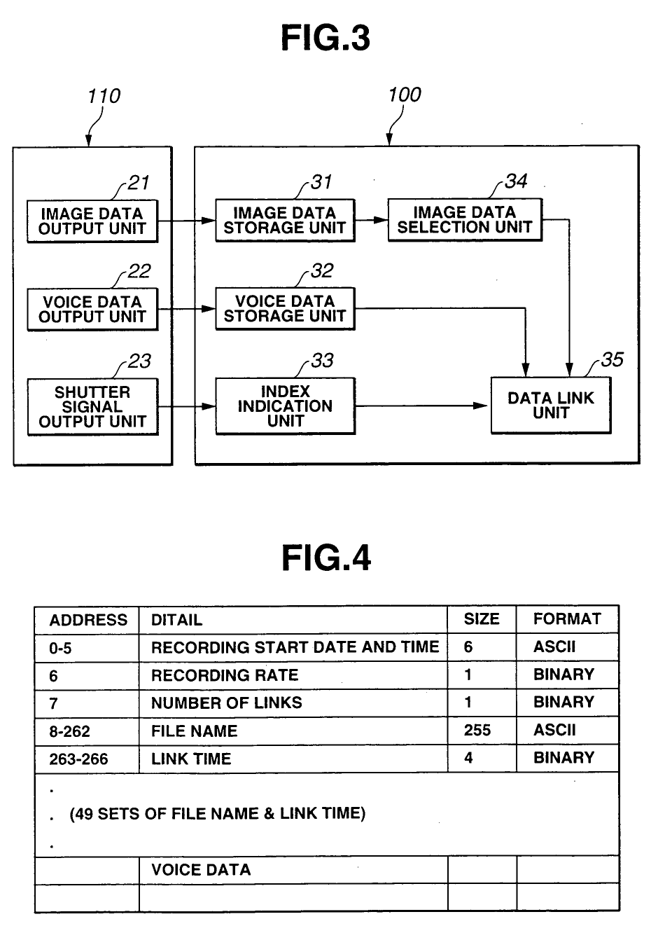

Referring to FIG. 3, the system control unit 12 comprises an image data output unit 21, for outputting image data stored in the storage unit 13 to the personal computer body 101, an audio data output unit 22, for outputting audio data stored in the storage unit 13 to the personal computer body 101, and a shutter signal output unit 23, for outputting a timing signal to the personal computer body 101 when the shutter button 14c is turned on during the edit of an audio album, which will be described in detail later.

On the other hand, as data editing functions, the personal computer body 101 has: an image data storage unit 31 for storing image data externally supplied; an audio data storage unit 32 serving as recording means for converting audio signals, externally supplied, into audio data as digital signals and then storing the resultant data; an index indication unit 33 serving as indication means for outputting an index indication signal on the basis of a shutter signal output from the shutter signal output unit 23 to indicate a playback position in the audio data; an image data selection unit 34 serving as image selection means for selecting a plurality of image data stored in the image data storage unit 31 and sequencing the selected image data; and a data link unit 35 serving as data link means for linking each image data, selected by the image data selection unit 34, with the audio data output from the audio data storage unit 32 at the corresponding index position in the audio data in accordance with the predetermined sequence on the basis of the index indication signal output from the index indication unit 33.

It is not necessary to input image data to the personal computer body 101 using the above-mentioned digital recorder 110. If image data is suitable for an image file format such as a JPEG format whereby image data can be reproduced, image data can be directly downloaded externally. In the present embodiment, since an audio signal is converted into audio data as a digital signal in the digital recorder 110, digital signal processing for audio signals is not needed in the personal computer body 101. However, if the personal computer body 101 has a digital signal processing function, a microphone is connected to the personal computer body 101, an audio signal is converted into audio data as a digital signal through an internal process, and the audio data can be stored in the audio data storage unit 32.

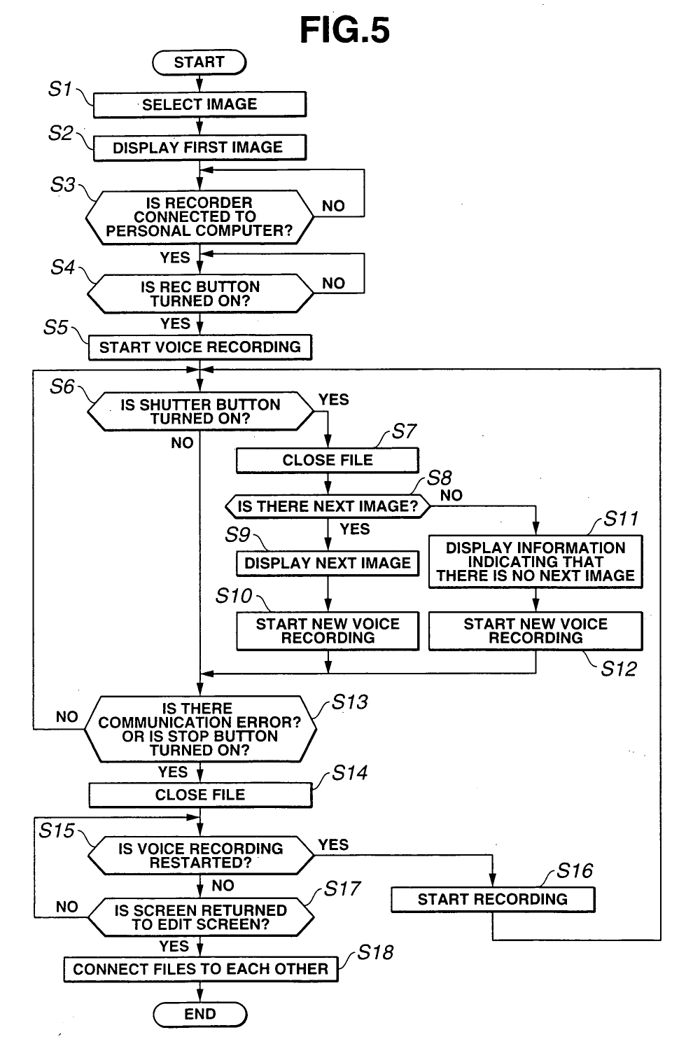

A data editing process of forming an audio album processed in the personal computer body 101 will now be described with reference to a flowchart of FIG. 5. For example, it is assumed that the operator of the digital recorder 110 visits exhibitions or roll-outs of new products, photographs the products using the digital recorder 110, and another day, he or she desires to add audio data as date and comments to the respective products photographed. First, the operator connects the digital recorder 110 to the personal computer body 101 through the data transmission cable 120, transfers image data, stored in the storage unit 13, from the image data output unit 21 to the personal computer body 101, and stores the image data in an image folder provided in the image data storage unit 31 of the personal computer body 101.

When editing the data with the personal computer 100, the operator selects an item of “New Document of Audio Album” from a menu displayed on the monitor 102 of the personal computer 100. Thus, a data editing routine shown in FIG. 5 is started. Then, first, in step S1, an audio album creation window is displayed on the monitor 102.

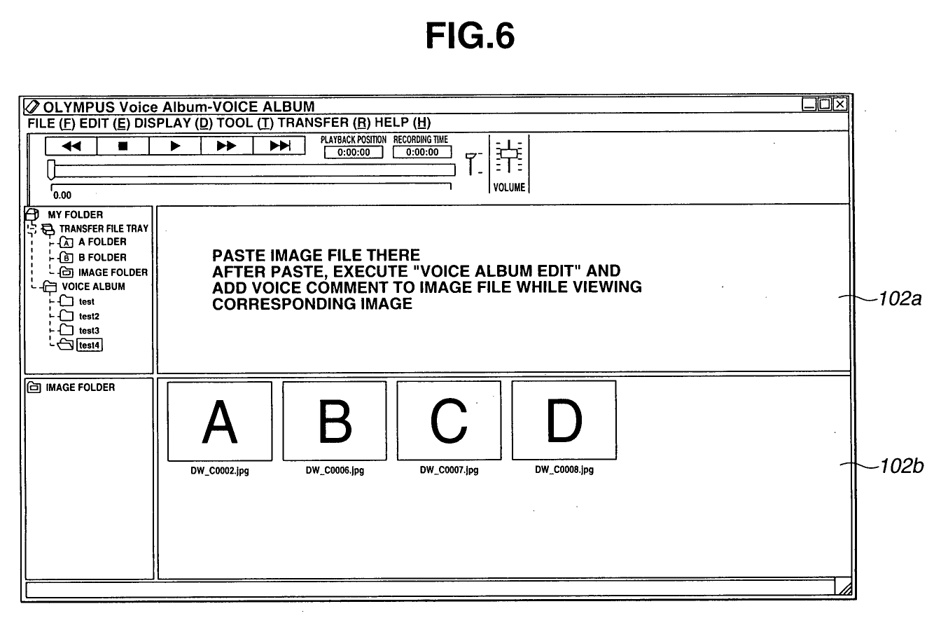

FIG. 6 shows a display example of the audio album creation window. Referring to FIG. 6, in the audio album creation window, two areas, namely, an audio view window 102a and an image view window 102b are displayed vertically. In the image view window 102b, image data stored in the image folder is displayed. In the present embodiment, for the convenience of description, four image data A to D are displayed in the image view window 102b. The number of image data is not limited to this example.

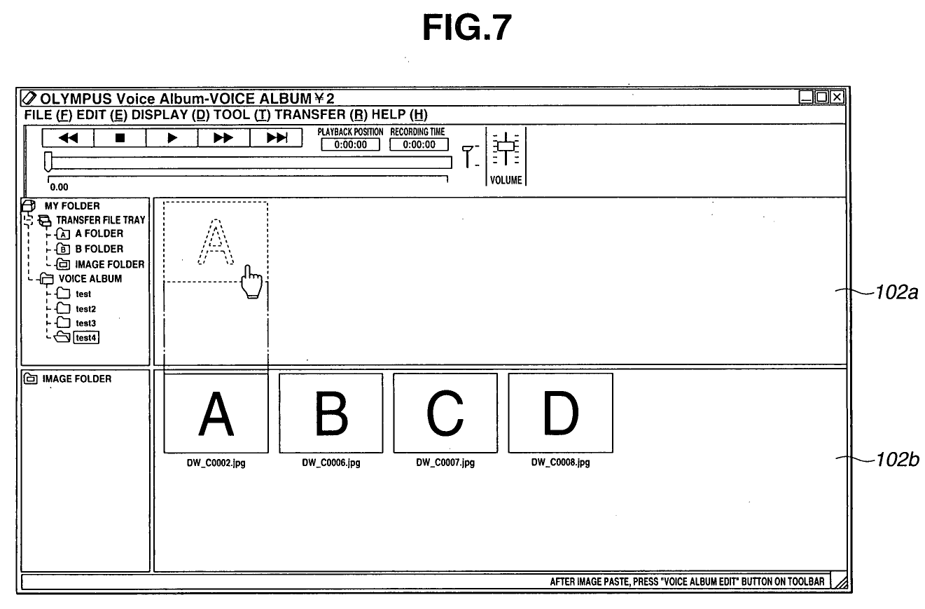

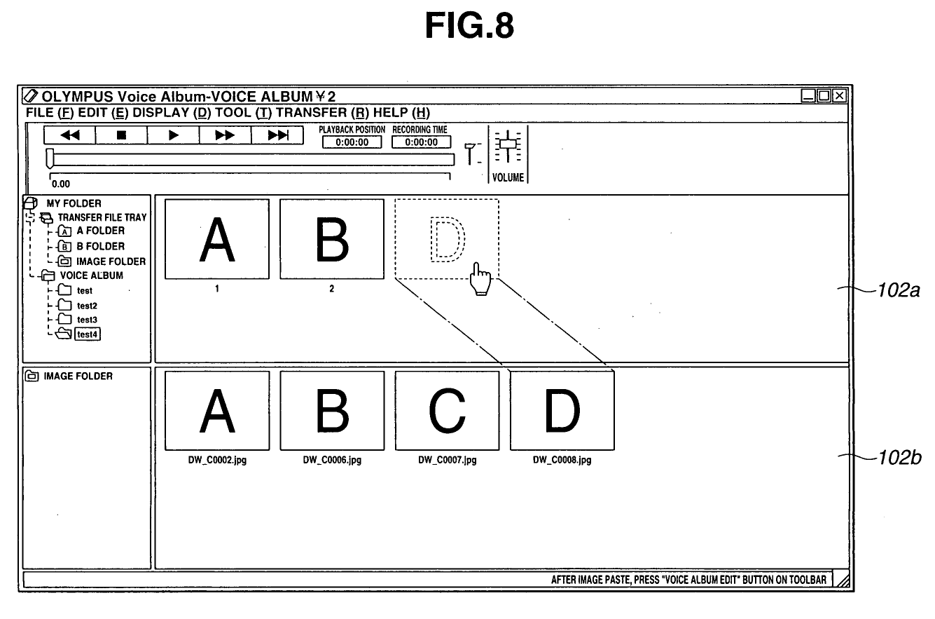

As shown in FIG. 7, the operator drags the image data displayed in the image view window 102b using the mouse 104 and then drops the image data in the audio view window 102a at the upper area, thus selecting the first image data (image “A” in FIG. 7). Then, the operator drags the second image data (image “B” in FIG. 8) in the image view window 102b using the mouse 104 and then drops the data in the audio view window 102a.

Drag-and-drop is one of operations for general computers and denotes a manner of realizing a desired function using a pointing device or an input device such as a keyboard. Specifically, the following series of manipulations are performed: A pointing device is controlled to move a pointer (index which is operatively associated with the operation of the pointing device), which is displayed on the display screen, to a target. A predetermined button on the pointing device is then pressed. While the button is being pressed, the pointing device is controlled to move (drag) the pointer to a desired position on the display screen. After that, the pressed button is released at the target desired position.

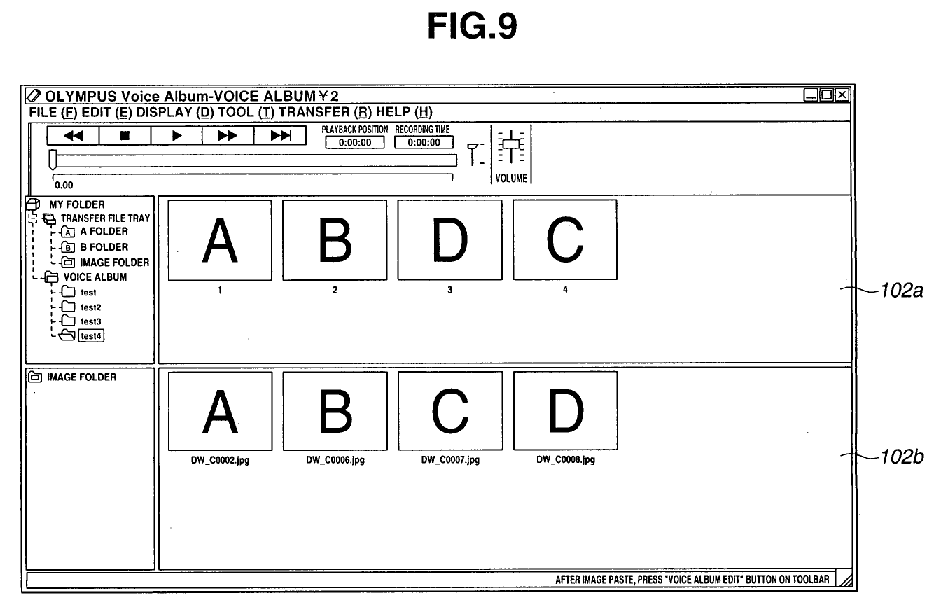

In the similar manipulations, the third and fourth image data (images “D” and “C” in FIG. 9) are selected. Thus, as shown in FIG. 9, in the present embodiment, the image data A, B, D, and C are set in the audio view window 102a in that order. After the order is set once, the order of A, B, D, and C can be changed by manipulations such as drag-and-drop.

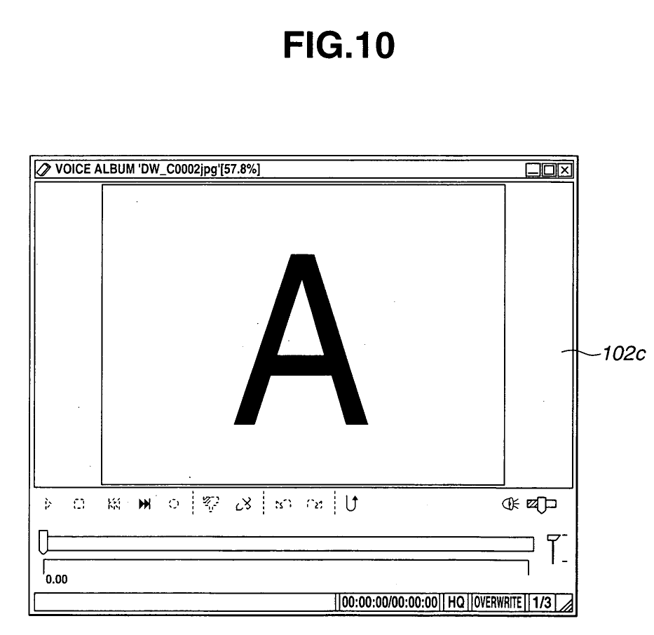

When the operator operates the mouse 104 and clicks on an icon of “Album Edit” displayed on the toolbar, the program proceeds to step S2. Thus, a first album edit window 102c as shown in FIG. 10 is displayed on the monitor 102. Then, the image data A selected first is displayed.

Subsequently, in step S3, whether the digital recorder 110 is connected to the personal computer body 101 through the data transmission cable 120 is checked. If NO, the program is in standby mode until the connection is determined. If the connection between the digital recorder 110 and the personal computer body 101 is detected, the program proceeds to step S4, in which, whether the sound recording button 14b is turned on is checked. The program is in standby mode until the sound recording button 14b is turned on. In the present embodiment, the sound recording button 14b of the digital recorder 110 is used as a sound recording button. For example, the operator can also click the mouse 104 on an icon (not shown), indicating a sound recording button, displayed on the toolbar of the monitor 102.

If the sound recording button 14b is turned on, the program proceeds to step S5. Sound recording is started. Simultaneously, a first audio file is opened. In this state, the operator inputs audio signals using, for example, the built-in microphone 3 in the digital recorder 110 and then stores audio data, obtained by converting the audio signals into digital signals, into the audio file, which is being opened, in the audio data storage unit 32 of the personal computer body 101 through the data transmission cable 120.

The program proceeds to step S6. Then, whether the shutter button 14c of the digital recorder 110 is turned on is checked. If NO, the program jumps to step S13. Whether any communication error is caused due to the disconnection of the data transmission cable 120 and the like or whether the stop button arranged in the multi-function button 14a is turned on is monitored. If any communication error does not occur or the stop button is not turned on, the program is returned to step S6 and sound recording is continued until the shutter button 14c is turned on.

If the shutter button 14c is turned on in step S6, the program branches to step S7, in which, the audio file in which the audio data related to the first image data is recorded is closed. FIG. 4 shows the structure of the audio file. As shown in FIG. 4, in a header portion added to the audio file, header information is recorded such that sound recording start date and time, a sound recording rate, the number of links, a file name, and link time are recorded every region with predetermined addresses.

After the audio file is closed in step S7, the program proceeds to step S8, in which, whether the next image data exists is checked. If YES, the program proceeds to step S9, in which, the next image data, namely, the second image data B is displayed in the above-mentioned album edit window 102c. The program proceeds to step S10, in which, a new audio file is opened to continue sound recording. Then, the program proceeds to step S13, in which, whether a communication error occurs and the state of the stop button are monitored. If any communication error does not occur and the stop button is not turned on, the program is returned to step S6. Sound recording related to the current image data is continued until the shutter button 14c is turned on.

When the shutter button 14c is again turned on, the audio file to record audio data related to the second image data B is closed. Current header information is recorded in a header portion added to this audio file.

In a manner similar to the above, an audio file to record audio data related to the third image data D and an audio file to record audio data related to the fourth image data C are formed. Header information, corresponding to each of the data D and C, is recorded in a header portion added to the corresponding audio file.

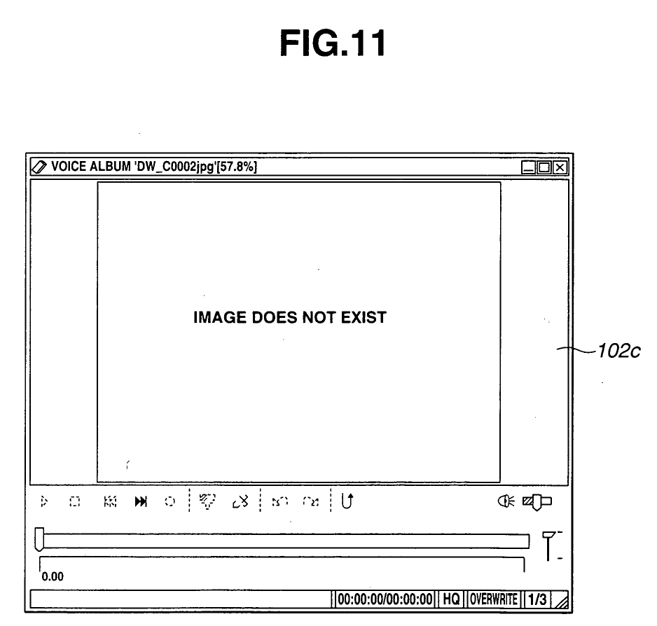

When the audio files corresponding to all of the image data are formed and there is no next image data, the program branches to step S11. As shown in FIG. 11, information indicating that there is no next image data is displayed in the album edit window 102c. The program proceeds to step S12. A new audio file is opened and sound recording is started.

According to the present embodiment, therefore, if there is no next image data, information indicating that there is no next image data is displayed in the album edit window 102c. Even in this state, a new audio file is opened each time the shutter button 14c is turned on.

In step S13, if the stop button is turned on during sound recording, alternatively, if a communication error is caused due to the disconnection of the data transmission cable 120, the program proceeds to step S14. In step S14, the sound recording is terminated and the audio file to record audio data, which has been last formed, is closed. Header information is recorded in a header portion added to that audio file. To stop sound recording, instead of the turn-on of the stop button in the digital recorder 110, the operator can click on an icon (not shown), indicating a stop button, displayed on the toolbar of the monitor 102.

Subsequently, the program proceeds to step S15, in which, whether sound recording is restarted is checked. Whether sound recording is restarted is checked on the basis of whether the sound recording button 14b is turned on. In this case, if the audio file has been closed because of a communication error, whether sound recording is restarted can also be determined on the basis of whether communication is recovered due to the reconnection of the data transmission cable 120.

If it is determined that the sound recording button 14b is turned on to restart sound recording, alternatively, if it is determined that the communication is recovered to restart sound recording, the program proceeds to step S16, in which, sound recording is restarted such that the current sound recording is added to the preceding sound recording. Then, the program is returned to step S6.

If the sound recording button 14b is not turned on, or if the communication error is continued, the program proceeds to step S17, in which, whether the operator clicks the mouse 104 on an icon (not shown), indicating that the screen of the monitor is returned to an edit screen, is determined. If NO, the program is returned to step S15.

Therefore, for example, if the operator turns on the stop button and, after that, he or she does not turn on the sound recording button 14b and does not click on the icon indicating the return to the edit screen, the program is in standby mode. In this state, the operator can also operate the fast-forward button (FF), the fast-rewind button (REW) or the like to select a desired image among images linked to audio files, select a desired audio file to which the desired image is linked, and perform editing operations such as partially erasing, additionally sound recording, and sound recording in overwrite mode.

After that, when the operator clicks on the icon indicating the return to the edit screen, the edit screen as the initial screen shown in FIG. 9 is displayed on the monitor 102. On the other hand, the program proceeds to step S18, in which, all of audio files currently formed are connected to each other in the order of selection, the respective image data are linked as indexes with the connected audio files in that order such that each image data is inserted between the audio files, thus forming an audio album. Then, the routine is exited. When those audio files are assembled into one audio file, data recorded in the header portion added to the audio file, namely, the number of links, file names of linked images, and link times are updated. Each link time is updated to a time position from the head of the resultant audio file.

Consequently, one audio data and image data related thereto are stored in one audio album. Each image data is linked as an index to one audio data. Therefore, upon playback, when image data is designated, a playback position of the corresponding audio data is indicated, so that the audio data related to the image data is played back.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A data editing apparatus comprising:
image selection means for sequencing a plurality of image data to sequentially select the image data;
recording means for converting supplied audio signals into audio data as digital signals to record the resultant data;
indication means for indicating a playback position in the audio data to be linked with the corresponding image data; and
data link means for linking each image data, selected by the image selection means, with the audio data at the corresponding playback position, indicated by the indication means, in the sequence.

2. A data editing method comprising:
a step of sequencing a plurality of image data to sequentially select the image data;
a step of starting a sound recording operation for converting supplied audio signals into audio data as digital signals to record the resultant data;
a step of indicating a playback position in the audio data to be linked with the corresponding image data;
a step of terminating the sound recording; and
a step of linking each selected image with the audio data at the corresponding indicated playback position in the sequence.

3. A data editing program which allows a computer to edit audio data and image data, the program comprising:
a step of allowing an operator to sequence a plurality of image data to sequentially select the image data;
a step of starting a sound recording operation for converting supplied audio signals into audio data as digital signals to record the resultant data;
a step of allowing the operator to indicate a playback position in the audio data to be linked with the corresponding image data;
a step of terminating the sound recording operation; and
a step of linking each selected image with the audio data at the corresponding indicated playback position in the sequence.
